(19) United States
(12) Patent Application Publication
(10) Pub. No.: US 2026/0184385 A1
(43) Pub. Date: Jul. 2, 2026

(54) COMPOSITE WALL STRUCTURE

(71) Applicant: Ridge Corporation, Pataskala, OH (US)

(72) Inventors: Gary Alan Grandominico, Galena, OH (US); Raymond Augustus McDonald, JR., Pooler, GA (US); Bret Jameson Moss, Lewis Center, OH (US)

(21) Appl. No.: 19/341,607

(22) Filed: Sep. 26, 2025

Related U.S. Application Data
(60) Provisional application No. 63/699,265, filed on Sep. 26, 2024.

(51) Int. Cl. B62D 29/04; B32B 3/04; B32B 5/18; B32B 27/06; B62D 33/04; B62D 35/00; B65D 90/02

(52) U.S. Cl. CPC B62D 29/045; B32B 3/04; B32B 5/18; B32B 27/065; B62D 33/046; B62D 35/002; B65D 90/022; B32B 2250/03; B32B 2250/24; B32B 2250/40; B32B 2607/00

(57) ABSTRACT

A wall structure for commercial transportation equipment and containers. The wall structure includes outer skins with core material and a thermoplastic laminate reinforcement positioned between the outer skins such that the thermoplastic laminate reinforcement is selectively arranged at portions of the wall structure to provide strength and stiffness. The wall structure is thermoformable to provide integrated features that integrally extend from the structure to accommodate design features and attachment supports.

This application claims priority to and any other benefit of U.S. Provisional Patent Application Ser. No. 63/699,265 filed Sep. 26, 2024, the contents of which are incorporated herein in their entirety by reference.

### TECHNICAL FIELD

An improved wall structure for commercial transportation equipment and, in particular, a wall structure having outer skins with core material and a thermoplastic laminate reinforcement positioned between the outer skins such that the thermoplastic laminate reinforcement is arranged at an edge of the wall structure, for example a top edge or bottom edge. This concept can be used to reinforce lightweight structural panels in key areas to provide additional strength, stiffness, or durability to transportation equipment and containerized freight containers. The reinforced region of the wall structure may provide a solid surface that is substantially non-compressible for secure attachment of components.

### BACKGROUND

Wall systems or structures in the transportation industry generally include a combination of aluminum extrusions located at the top and bottom of the wall, often referred to as top rails and bottom rails, and series of wall panels referred to as plate or composite plates. The plates are generally 48 inches wide and connected along their vertical edges with reinforcing posts or doubler plates, which can be called side or logistic posts.

The top and bottom rails are often continuous aluminum or metal extrusions that extend the full length of the wall assembled by plates, which can be in the range of 12 to 57 feet. The sidewall plates or panels are assembled by connecting smaller plates that can be in the range of 48 inches wide by 110 inches high together with the side posts to assemble a finished wall structure or panel that is 12 to 57 feet in length.

The top and bottom metal rails are fastened, usually riveted or glued, to the wall structure to create a full height sidewall structure that can be approximately 110 to 124 inches in height. The wall structure works as a structural member, I-beam, with the top and bottom metal rails acting similar to top and bottom flanges of the I-beam and the sidewall structure acting as the web of the I-beam. These wall assemblies are designed to support freight loads that are transmitted to the sidewall structure via I-beam crossmembers, both aluminum or steel, that are fastened (e.g., bolted or riveted) to the bottom metal rail of the sidewall structure. These sidewall structures can be made from aluminum skin sheet 0.040-0.050 inch thick coupled with steel or aluminum extruded posts or composite panels made of steel skins laminated to a polymer core. These “traditional” composite panels are generally 48 inch×110 inch×0.25 inch in dimension and are joined by metal posts or by an overlapping arrangement of exterior steel skins.

Alternative designs of sidewall panels include a monolithic FRP (fiber reinforced plywood) wall. FRP panels are generally assembled from 4 foot×10 foot sheets of plywood (the core) which are coated with sheets of woven glass fabric which in turn are saturated with thermoset polyester resin and cured to make a finished panel. The finished panel is attached to a metal top and bottom rail to produce the FRP sidewall assembly

The present invention aims to reduce the weight of wall structures while providing a reinforced portion in a composite structure for ease of use of top or bottom rails and molding of the wall structure to accommodate design features and structural connections.

### SUMMARY

The following is a brief summary of subject matter that is described in greater detail herein. This summary is not intended to be limiting as to the scope of the claims.

In a first aspect, there is disclosed a composite wall structure for a container, such as a transportation container. The composite wall structure includes, along its perimeter, a top edge surface, a bottom edge surface, a first side surface and a second side surface, and on its faces there is an inner polymeric skin forming a first wall surface and an outer polymeric skin forming a second wall surface. Between the wall surfaces formed by the polymeric skins resides a core material. The composite wall structure further includes a thermoplastic laminate reinforcement or layer positioned between the inner polymeric skin and the outer polymeric skin, the thermoplastic laminate reinforcement is located at the top edge surface or the bottom edge surface of the composite wall structure, and the thermoplastic laminate reinforcement is made of a different material than that of the core material. As arranged in the composite wall structure, the core material and the thermoplastic laminate reinforcement are thermally fused to the inner polymeric skin and the outer polymeric skin.

In an example of aspect 1, the thermoplastic laminate reinforcement extends along the entire top edge surface or the bottom edge surface of the perimeter of the composite wall structure.

In another example of aspect 1, the composite wall structure further includes a second thermoplastic laminate reinforcement, wherein the thermoplastic laminate reinforcement extends along the entire top edge surface, the second thermoplastic laminate reinforcement extends along the entire bottom edge surface, and the core material is positioned between the thermoplastic laminate reinforcement and the second thermoplastic laminate reinforcement. In a further example, the first or second thermoplastic laminate reinforcement is in direct contact with, for instance thermally fused to, both the inner polymeric skin and the outer polymeric skin. The core material, positioned adjacent the first or second thermoplastic laminate reinforcement can be in direct contact with an edge of the laminate reinforcement.

In another example of aspect 1, the thermoplastic laminate reinforcement abuts and is in direct contact with the core material to form a continuous material between the inner polymeric skin and the outer polymeric skin.

In another example of aspect 1, the inner polymeric skin and the outer polymeric skin are each continuous and form the respective entire height and width of the first wall surface and the second wall surface. In a further example, the polymeric skins are reinforced with fibers.

In another example of aspect 1, the top edge surface of the composite wall structure is thermoformed to form an integrated attachment surface. In an example, the integrated attachment surface is non-parallel with the first wall surface and the second wall surface.

In another example of aspect 1, the integrated attachment surface is formed as a 90-degree bend at the top edge portion of the composite wall structure.

In another example of aspect 1, the thermoplastic laminate reinforcement is located at the bottom edge surface, and the outer polymeric skin at the bottom edge surface extends downward below the adjacent bottom end of the inner polymeric skin and/or the thermoplastic laminate reinforcement arranged between the skins, to form an aerodynamic extension in the form of single polymeric skin layer portion. In an example, the aerodynamic extension is free from being in contact with the core material, the thermoplastic laminate reinforcement, another polymeric skin, or any combination thereof.

In another example of aspect 1, the second wall surface and the aerodynamic extension are a continuous surface formed by the outer polymeric skin. In an example, the outer polymeric skin is fiber reinforced.

In another example of aspect 1, the core materials is a foam or honeycomb material and the thermoplastic laminate reinforcement is made of a polymeric material. The polymeric material of the reinforcement may be the same material as used for the inner and outer polymeric skins, and may be further fiber reinforced.

In another example of aspect 1, the core material and the thermoplastic laminate reinforcement are in direct contact with one another and the inner polymeric skin and the outer polymeric skin.

In another example of aspect 1, the thermoplastic laminate reinforcement surrounds the entire core material positioned between the inner polymeric skin and the outer polymeric skin. The thermoplastic laminate reinforcement may be positioned between the inner and outer polymeric skins such that it fills space between the skins around the perimeter surfaces of the composite wall structure to form a reinforcement border at or near the perimeter edges of the wall, and the core material is arranged between the skins away from the reinforcement border but also is in direct contact with the reinforcement border.

In another example of aspect 1, at least one of the inner polymeric skin and the outer polymeric skin extend past both the core material and the thermoplastic laminate reinforcement, and the extension portion of the at least one of the inner polymeric skin and the outer polymeric skin is not in contact with the core material, the thermoplastic laminate reinforcement, another polymeric skin, or any combination thereof.

In another example of aspect 1, the entire first wall surface is formed by the inner polymeric skin and the entire second wall surface is formed by the outer polymeric skin.

In another example of aspect 1, the top edge surface or the bottom edge surface of the composite wall structure includes a portion of the thermoplastic laminate reinforcement present at or near the top or bottom edge surface extending beyond an edge of the inner polymeric skin and/or outer polymeric skin at the top or bottom edge surface. In an example, the top edge surface or the bottom edge surface of the composite wall structure includes a portion of the thermoplastic laminate reinforcement present at or near the top or bottom edge surface extending below an edge of the inner polymeric skin and/or outer polymeric skin at the top or bottom edge surface.

In another example of aspect 1, there is a transportation trailer that includes a front wall, a first sidewall and a second sidewall, the composite wall structure of aspect 1 is at least one of the front wall, the first sidewall and the second sidewall of the transportation trailer.

In a second aspect, there is disclosed a composite wall structure for a transportation container, the composite wall structure includes a top edge surface, a bottom edge surface, a first side wall surface and a second side wall surface, the first and second side wall surfaces make up an exterior surface of the composite wall structure, an inner polymeric skins forming the first side wall surface and an outer polymeric skin forming the second side wall surface. A foam core material is positioned between the inner polymeric skin and the outer polymeric skin along with a first thermoplastic laminate reinforcement and the first thermoplastic laminate reinforcement extends along the entire top edge surface of the wall and as such the first thermoplastic laminate reinforcement makes up a portion of the top edge surface of the perimeter between the skins. A second thermoplastic laminate reinforcement is positioned between the inner polymeric skin and the outer polymeric skin, the second thermoplastic laminate reinforcement extends along the entire bottom edge surface and as such the second thermoplastic laminate reinforcement makes up a portion of the bottom edge surface of the perimeter between the skins. As arranged in the wall structure, the foam core material, the first thermoplastic laminate reinforcement, and the second thermoplastic laminate reinforcement are thermally fused to the inner polymeric skin and the outer polymeric skin, and the inner polymeric skin and the outer polymeric skin are continuous and form the respective entire height and width of the first side wall surface and the second side wall surface.

In an example of aspect 2, the top edge surface is thermoformed to form an integrated attachment surface, the integrated attachment surface being non-parallel with the first side wall surface and the second side wall surface. The thermoformed integrated attachment surface section of the composite wall structure is integral with the first and second side wall surfaces and includes a portion of the first thermoplastic laminate reinforcement that is arranged between the inner and outer polymeric skins. In an example, the entire integrated attachment surface section consists of a portion of each of the inner and outer polymeric skins and first thermoplastic laminate reinforcement. The integrated attachment surface section is free of the core material.

In another example of aspect 2, the integrated attachment surface section includes a curved portion and a lip portion that includes a planar section that is substantially perpendicular with the planar surfaces of the first and second side wall surfaces.

In another example of aspect 2, the integrated attachment surface section forms the top edge surface of the composite wall structure. The top edge surface can be non-parallel with the bottom edge surface and, for instance, can be substantially perpendicular with the bottom edge surface.

In another example of aspect 2, the outer polymeric skin at the bottom edge surface extends downward below the adjacent bottom end of the inner polymeric skin and the second thermoplastic laminate reinforcement to form an aerodynamic extension.

In a third aspect, there is disclosed a composite wall structure for use as a component of a transportation container. The composite wall structure includes a composite wall portion that forms an entire sidewall of the transportation container, the composite wall portion has a top edge surface, a bottom edge surface, a first side wall surface and a second side wall surface. The first side wall surface is made of an inner polymeric skin and the second side wall surface is made of an outer polymeric skin. A core material is positioned between the inner polymeric skin and the outer polymeric skin to form the wall portion. From the wall portion, an aerodynamic extension is formed by a portion of the outer polymeric skin that extends downward from the composite wall portion and below the inner polymeric skin and a bottom side of the transportation container.

In an example of aspect 3, the aerodynamic extension includes a lip at the bottom edge of the aerodynamic extension, the lip contains a portion of the outer polymeric skin folded onto itself.

In another example of aspect 3, the aerodynamic extension consists of a polymeric, fiber-reinforced material. The polymeric material may be a thermoplastic and the aerodynamic extension may be made by thermoforming the portion of the outer polymeric skin extending from the wall portion.

The above aspects (or examples of those aspects) may be provided alone or in combination with any one or more of the examples of that aspect or another aspect discussed above; e.g., the first aspect may be provided alone or in combination with any one or more of the examples of the first aspect, second aspect, third aspect or other aspects discussed above.

The above summary presents a simplified summary in order to provide a basic understanding of some aspects of the compositions, items of manufacture, and/or methods discussed herein. This summary is not an extensive overview of the subject matter discussed herein. Its sole purpose is to present some concepts in a simplified form as a prelude to the more detailed description that is presented later.

### BRIEF DESCRIPTION OF THE DRAWINGS

The present disclosure is better understood when the following detailed description is read with reference to the accompanying drawing. The drawings constitute a part of this specification and include exemplary embodiments of the invention, which may also be embodied in various forms. It is further understood that in instances the aspects of the invention may be shown exaggerated or enlarged to facilitate a particular understanding of the invention.

FIG. 1A shows an example composite wall structure that includes a reinforcement portion that extends along a top edge of the composite wall. The reinforcement portion abuts a core material arranged between an inner and outer skin of the composite wall structure.

FIGS. 1B and 1C show an example composite wall structure that includes multiple reinforcement portions that extend along a top and a bottom edge of the composite wall. The reinforcement portions abut a core material arranged between an inner and outer skin of the composite wall structure.

FIGS. 2A and 2B show an example composite wall structure that includes a thermoplastic laminate reinforcement that extends along a bottom edge of the composite wall and abuts a core material arranged between an inner and outer skin of the composite wall structure.

FIGS. 3A and 3B show an example composite wall structure that includes an integrated shape along an edge of the wall structure for accommodating a structural component. The integrated shape is shown as a 90-degree bend that forms a lip that extends along an edge of the wall structure. The 90-degree bend is integral and continuous to the composite wall structure such that the inner and outer skins, and material between the skins, extend from the primary wall structure to form the integrated shape.

FIGS. 4A, 4B and 4C show an example composite wall structure that includes an aerodynamic extension that extends along an edge of the wall structure for forming an aerodynamic lower curtain. The aerodynamic extension is integral and continuous to the composite wall structure and, as shown, is formed by the outer skin of the wall structure extending from the primary wall structure. When used as a wall of a trailer, the aerodynamic extension can reduce drag during operation and improve fuel consumption and related costs.

The above examples or aspects may be provided alone or in combination with any one or more of the examples discussed above; e.g., a first example may be provided alone or in combination with any one or more of the remaining examples or other aspects discussed above.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### DETAILED DESCRIPTION

The terminology as set forth herein is for description of the embodiments only and should not be construed as limiting the invention as a whole.

Herein, when a range such as 5 -25 (or 5 to 25) is given, this means preferably at least or more than 5 and, separately and independently, preferably not more or less than 25. In an example, such a range defines independently 5 or more, and separately and independently, 25 or less.

The present disclosure relates to a composite wall structure having reduced weight and one or more reinforced edge portions that eliminate the need for secondary components attached to known wall, for example, top rails and bottom rails, for protecting or joining the wall or segments thereof or providing an attachment area for securing additional hardware or fixtures. The composite wall structure can be used for constructing a wall of a container, for example, a transportation container, storage unit, trailer, refrigeration unit, recreational tailer or vehicle, or the like. Other advantages of the invention are apparent from the descriptions, in combination with the drawings, whereby by way of illustration and example embodiments of the invention are disclosed.

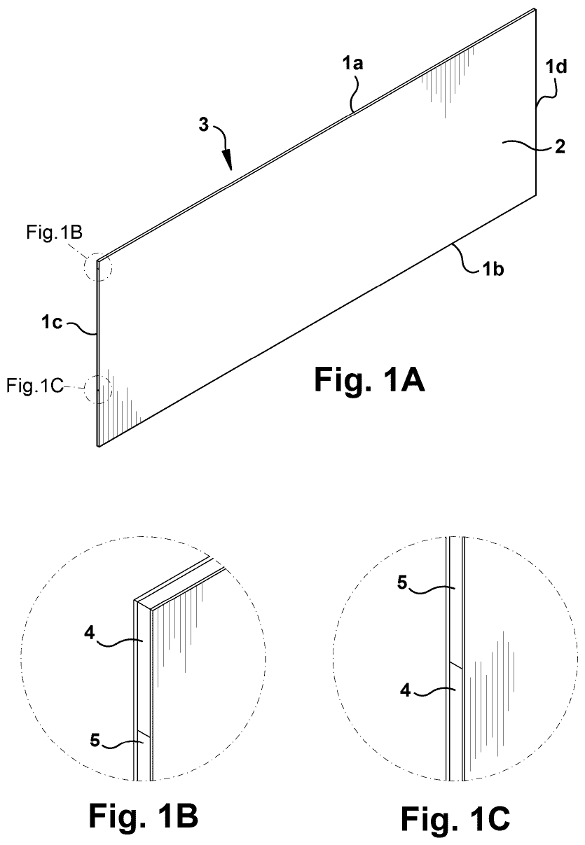

The composite wall structure has a perimeter surface that includes a top edge surface, a bottom edge surface, a first side surface and a second side surface, and two exterior faces that include a first wall surface and a second wall surface. A top edge surface can include the top edges of an inner polymeric skin, an outer polymeric skin, or a combination of both, which may be aligned and level with one another as shown in FIG. 1A. A bottom edge surface CLEAN can include the bottom edges of an inner polymeric skin, an outer polymeric skin, or a combination of both, which may be aligned and level with one another as shown in FIG. 1A.

The wall surfaces may be made of a polymeric material that forms a skin or layer. For instance, an inner polymeric skin may form the first wall surface. The first wall surface may face or be an interior wall surface of a container. An outer polymeric skin may form the second wall surface. The second wall surface may face or be an exterior wall surface of a container, which faces opposite the first wall surface.

The polymeric skins used for the first and second wall surfaces may be the same material. The polymeric skins may form the entire first and second wall surfaces such that the wall surfaces are a continuous surface. The skins include a polymeric material, which can be the sole material, excluding any fiber reinforcement, that forms the skins. The polymeric material can be a single sheet that forms an outermost surface, for example the outer or inner face, of the composite wall structure. The polymeric material can include a thermoplastic material. Polymeric material can include, but is not limited to, polypropylene, polyethylene, poly vinyl chloride, polycarbonate, polyacrylic, polymethylmethacrylate, polystyrene, and combinations thereof. The polymeric or thermoplastic material of the inner or outer polymeric skin can be reinforced to strengthen the material and provide rigidity to the wall surfaces of the composite wall structure.

Reinforcement materials for the polymeric skins can include fibers, for example, continuous, discontinuous, or chopped fibers. Fibers can include any suitable fiber or combination of fibers, for instance, glass, polyamide, polyester, cellulose, carbon, aramid and the like. The outer polymer skin, and the inner polymeric skin, can be single layer or two or more layers laminated together (e.g., a multilaminate layer) as desired.

A core material is positioned in the central area between the inner and outer polymeric skins that form the wall surfaces of the composite wall structure. The core material provides integral strength and rigidity to the wall and, in instances, insulating properties, without resulting in significant weight increase. The core material is sandwiched between portions of the inner polymer skin and the outer polymeric skin. In some embodiments, the core material is adhered directly to the inner polymeric skin, the outer polymeric skin, or both skins. Any suitable adhesive or bonding agent can be used to adhere the core material to the skins. In another example, the core material and skins can be formed together by thermoforming the composite wall structure. In other examples, the core material can be constructed of continuous or discontinuous sections that are positioned in the center of the wall height and in between the inner and outer skins providing the desired finished thickness of the composite wall structure.

The core material can be any suitable material, for example, a honeycomb or a foam. Examples of a foam can include, for instance, closed cell foams (ethylene vinyl acetate foam), polyethylene foams, polypropylene foams, and neoprene foams, and open cell foams such as polyurethane or polyether- or polyester-based polyurethane foams.

The composite wall structure has one or more thermoplastic laminate reinforcements arranged between the inner and outer polymeric skins that form the wall surfaces of the composite wall structure. The thermoplastic laminate reinforcement provides improved strength and rigidity to select sections of the wall while also balancing weight impact by other sections of the wall to include the core material. The thermoplastic laminate reinforcements are designed to provide and/or replace the stiffness and strength of the traditional aluminum extruded top and bottom rails with the tensile and compressive strengths needed for the composite wall structure. In an example, the thermoplastic laminate reinforcements provide solid, rigid surface that are not sufficiently compressible and provide strength for mounting (e.g., bolting) components to the sections of the composite wall structure that contain the thermoplastic laminate reinforcements.

The thermoplastic laminate reinforcements are sandwiched between desired portions of the inner polymer skin and the outer polymeric skin. In some embodiments, the thermoplastic laminate reinforcement is adhered directly to the inner polymeric skin, the outer polymeric skin, or both skins. Any suitable adhesive or bonding agent can be used to adhere the thermoplastic laminate reinforcement to the skins. In another example, the thermoplastic laminate reinforcement and skins can be formed together by thermoforming the composite wall structure. The thermoforming of the composite wall structure may form unique structural shapes or modifications at areas of the wall that include the thermoplastic laminate reinforcement. The thermoforming process of molding the composite wall structure can thermally fuse the polymeric skins and the thermoplastic laminate reinforcement together.

Once the wall components are arranged or assembled in a non-final wall, pressure and heat may applied to raise all the proximate edges and surfaces to a temperature that allows the thermoplastic materials to bond together at a molecular level. This bonding/fusing/welding provides a continuous joint that is effective at transmitting force and resulting in a high strength assembly. The finished composite wall structure has a consistent thickness over its entire area where core material and thermoplastic laminate reinforcement are positioned. By incorporation of the one or more thermoplastic laminate reinforcements, the function of traditional aluminum rails that are positioned at the top and/or bottom of the wall has been moved from the an exterior of the wall to the interior of the composite wall structure. The fusing of the thermoplastic components of the improved composite wall structure eliminates the need for fasteners or glue to attach the rails to the wall panel. The resulting wall structure can provide lighter weight and higher strengths than that of traditional constructions and composite walls. Logistic capability of a container structure made with the improved composite wall structure is achieved by fastening logistical components such as E track or decking tracks through the entire thickness, through the skin, bonded, or a combination of these methods.

In another example, the thermoplastic laminate reinforcement is a lightweight, multi-layer fiber reinforced composite material that couples with the inner and outer skins through a continuous process. The reinforcement provides added strength and stiffness properties suitable for floor loading applications and assembly scenarios.

The thermoplastic laminate reinforcement may be made of a polymeric material. The polymeric material can include a thermoplastic material. Polymeric material can include, but is not limited to, polypropylene, polyethylene, poly vinyl chloride, polycarbonate, polyacrylic, polymethylmethacrylate, polystyrene, and combinations thereof. The polymeric or thermoplastic material of the thermoplastic laminate reinforcement can be reinforced to strengthen the material and provide rigidity to an entire cross-section, not to only the exterior surface, of the composite wall structure. In one or more embodiments, the thermoplastic laminate can include the same polymeric material present in the inner and outer polymeric skins. The polymeric material of the thermoplastic laminate reinforcement can be a build up of material to join the inner and outer skins together prior to thermoforming the composite wall structure.

Reinforcement materials for the thermoplastic laminate reinforcement can include fibers, for example, continuous, discontinuous, or chopped fibers. Fibers can include any suitable fiber or combination of fibers, for instance, glass, polyamide, polyester, cellulose, carbon, aramid and the like. The thermoplastic laminate reinforcement can be single layer or two or more layers laminated together (e.g., a multilaminate layer) as desired.

In one or more embodiments, the composite wall structure has a thermoplastic laminate reinforcement positioned at or near the top edge section of the wall. The thermoplastic laminate reinforcement can form a portion of the top edge surface of the wall and extend from the top edge surface inward into the interior of the wall between the inner and outer polymeric skins.

In other instances, the thermoplastic laminate reinforcement can form a portion of a top edge area of the wall such that the reinforcement can extend above or below the adjacent inner and outer polymeric skins. In such instances, the thermoplastic laminate reinforcement nevertheless forms a portion at or near the top edge surface of the composite wall structure even when the edges of the inner polymeric skin, outer polymeric skin and thermoplastic laminate reinforcement are not exactly aligned with one another to form a flat edge surface.

The thermoplastic laminate reinforcement may occupy the entire space between the inner and outer polymeric skins at the top edge section of the composite wall structure to provide a rigid perimeter section at the top of the wall. The thermoplastic laminate reinforcement can extend along the entire length of the top edge section of the composite wall structure. In an example, the thermoplastic laminate reinforcement can occupy the top section between the inner and outer polymeric skins and extend from the top edge surface at least 3, 6, 8, 10, 12, 14, 18, 20, 24, 28 or 36 inches towards the bottom edge of the wall.

The thermoplastic laminate reinforcement may also, either alone or in combination with forming a section at or near the top edge section of the wall, occupy the entire space between the inner and outer polymeric skins at the bottom edge section of the composite wall structure to provide a rigid perimeter section at the bottom of the wall. The thermoplastic laminate reinforcement can extend along the entire length of the bottom edge section of the composite wall structure. In an example, the thermoplastic laminate reinforcement can occupy the bottom section between the inner and outer polymeric skins and extend from the bottom edge surface at least 3, 6, 8, 10, 12, 14, 18, 20, 24, 28 or 36 inches towards the top edge of the wall.

In one or more embodiments, the thermoplastic laminate reinforcement may form and occupy the entire space between the inner and outer polymeric skins at the perimeter edges of the composite wall structure. For instance, the thermoplastic laminate reinforcement can form a frame section at the perimeter edges of the wall and make up a portion, area between the edges of the inner and outer skins, of the top edge surface, the bottom edge surface, the first side surface and the second side surface. From the perimeter edges of the composite wall structure, the thermoplastic laminate reinforcement can extend from the perimeter edge surfaces at least 3, 6, 8, 10, 12, 14, 18, 20, 24, 28 or 36 inches towards the center area of the wall.

As arranged at one or more edge sections of the composite wall structure, the thermoplastic laminate reinforcement, being a different material than the core material, may abut and directly contact the core material positioned between the inner and outer polymeric skins. In one or more embodiments, the combination of the thermoplastic laminate reinforcement or plural thermoplastic laminate reinforcements and the core material can be the sole materials that occupy the entire space between the inner and outer polymeric skins. In one example, the thermoplastic laminate reinforcement forms the top 3 to 36 inches between the polymeric skins of the composite wall structure along the entire top edge surface and the core material occupies the entire remaining area between the polymeric skins such that the core material is arranged below the thermoplastic laminate reinforcement. In another example, the thermoplastic laminate reinforcement forms the bottom 3 to 36 inches between the polymeric skins of the composite wall structure along the entire bottom edge surface and the core material occupies the entire remaining area between the polymeric skins such that the core material is arranged above or on top of the thermoplastic laminate reinforcement. In yet another example, the thermoplastic laminate reinforcement forms the entire perimeter edge and occupies 3 to 36 inches between the polymeric skins of the composite wall structure along the entire perimeter edge surface (top, bottom and both sides) and the core material occupies the entire remaining area between the polymeric skins such that the core material is arranged inside of the thermoplastic laminate reinforcement frame around the perimeter of the composite wall structure.

In other embodiments, the composite wall structure may include integrated shapes at one or more of the edges of the panel to increase the strength and stiffness of the wall structure but to also provide attachment of other container structure parts such as lower cross member, roof, front and rear structural components. These shapes represent an integrated attachment surface that is continuous with the main portion of the composite wall structure and can be machined, thermoformed, or molded into the composite wall structure. An example structure can be a 90-degree radius curved section, as shown in the figures, to aid attachment of a roof sheet or provide a lip for a cross member to rest on. The integrated attachment surface preferably has planar or flat section that forms a shelf. The planar section of the integrated attachment surface is non-parallel with the primary portion of the composite wall structure, for example, the planar section may be perpendicular with the main first and second wall surfaces.

The integrated attachment surface preferably has the same or substantially the same width as the composite wall structure. To provide strength to the integrated attachment surface, a thermoplastic laminate reinforcement may occupy the area between the inner and outer skins in the entire area of the integrated attachment surface. The thermoplastic laminate reinforcement may extend from the integrated attachment surface towards the main portion of the composite wall structure where is contacts and terminates at core material arranged between the inner and outer polymeric skins. The integrated attachment surface may extend along and make up an entire perimeter edge surface, for example, the top edge surface, of the composite wall structure.

In other embodiments, for over-the-road applications, the composite wall structure for use in a container structure can include a section or aerodynamic extension that extends beyond a perimeter edge surface, e.g., the bottom edge of the wall and of the container structure, where structure such as cross members is typically attached. The aerodynamic extension, also shown as an example in the figures, creates an aerodynamic (e.g., an aerodynamic lower curtain) benefit to the over-the-road container structure by reducing drag during operation and thus further improving fuel consumption and costs. The drag is reduced by creating an integral and continual surface from the composite wall structure which airflow can cleanly travel towards the rear wake of the vehicle instead of flowing underneath the vehicle where it creates drag on the underbody components such as the cross members and suspension.

The aerodynamic extension may include an outer polymeric skin extending from the composite wall structure but also, in certain embodiments, contain the thermoplastic laminate reinforcement, core material, inner polymeric skin or any combination of these components. The aerodynamic extension can have integrated shapes formed at and extending from the edges of the wall to increase the strength and stiffness of the wall but to also provide resiliency. These shapes can be machined, thermoformed, or molded into a section or component of the composite wall structure. For instance, shapes may be a machined and thermoformed hem, fold or lip.

In one or more embodiments, the aerodynamic extension can be formed from an extension of one or more of the polymeric skins that make up the wall surfaces of the composite wall structure. For example, a portion of the outer polymeric skin, forming an outward facing wall of a container, can extend below of the bottom edge of the wall such that the portion of the outer polymeric skin extending downward is devoid of core material, thermoplastic laminate reinforcement, inner polymeric skin or any combination thereof. As an extension of an outer polymeric skin, the aerodynamic extension can form a continuous surface from the first or second wall surface. The aerodynamic extension can extend outward from a perimeter edge surface of the composite wall structure along the entire length of the edge surface or a portion thereof. For example, the aerodynamic extension may extend along at least 50, 60, 70, 80 90 or 100 percent of the edge length of the wall. The aerodynamic extension may extend from a perimeter edge of the composite wall structure any suitable distance, for instance, the distance of the aerodynamic extension may be at least 3, 6, 8, 10, 12, 14, 18, 20, 24, 28 or 36 inches. For example, the distance may be measured from an end edge surface of the aerodynamic extension to the perimeter edge surface of the composite wall structure.

Turning to the figures, FIG. 1a shows an illustration of a composite wall structure 1 having a top edge surface 1a, a bottom edge surface 1b, a first side surface 1c and a second side surface 1d. Composite wall structure 1 has two exterior faces that include a first wall surface 2 and a second wall surface 3, which is opposite first wall surface 2. First wall surface 2 is formed by an inner polymeric skin that provides a continuous, smooth surface face to wall 1. Second wall surface 3 is formed by an outer polymeric skin that provides a continuous, smooth surface face to wall 1. The entire top edge section of composite wall structure 1 has a thermoplastic laminate reinforcement 4 arranged between inner polymeric skin 2 and outer polymeric skin 3. Thermoplastic laminate reinforcement 4 forms a portion of top edge surface 1a along its entire length as it occupies the area between inner polymeric skin 2 and outer polymeric skin 3 at the top section of wall 1. Thermoplastic laminate reinforcement 4 also forms a portion of first side surface 1c and second side surface 1d as it occupies the area between inner polymeric skin 2 and outer polymeric skin 3 at the top side areas of wall 1.

Thermoplastic laminate reinforcement 4 directly contacts core material 5 arranged below. Core material 5 is positioned between inner polymeric skin 2 and outer polymeric skin 3 and occupies the remaining area between skins 2, 3 that is not filled with thermoplastic laminate reinforcement 4. Core material 5 also forms a portion of bottom edge surface 1b along its entire length as it occupies the area between inner polymeric skin 2 and outer polymeric skin 3 at the top section of wall 1. Portions of first side surface 1c and second side surface 1d are also formed by core material 5 as it occupies the area between inner polymeric skin 2 and outer polymeric skin 3 below the entire top side areas of wall 1.

FIG. 1b shows a section of the top corner area of composite wall structure 1. Thermoplastic laminate reinforcement 4 occupies the area between inner polymeric skin 2 and outer polymeric skin 3 along the top edge section of wall 1. Core material 5 contacts and fills the area between inner polymeric skin 2 and outer polymeric skin 3 below the entire bottom edge 4a of thermoplastic laminate reinforcement 4. FIG. 1c shows a side section area of composite wall structure 1 below thermoplastic laminate reinforcement 4. Core material 5 is the sole material occupying the area between inner polymeric skin 2 and outer polymeric skin 3 below thermoplastic laminate reinforcement 4 before transitioning to contact a second thermoplastic laminate reinforcement 4 along the bottom section of wall 1. Core material 5 is in contact with both thermoplastic laminate reinforcements 4, top and bottom, along the entire length of wall 1.

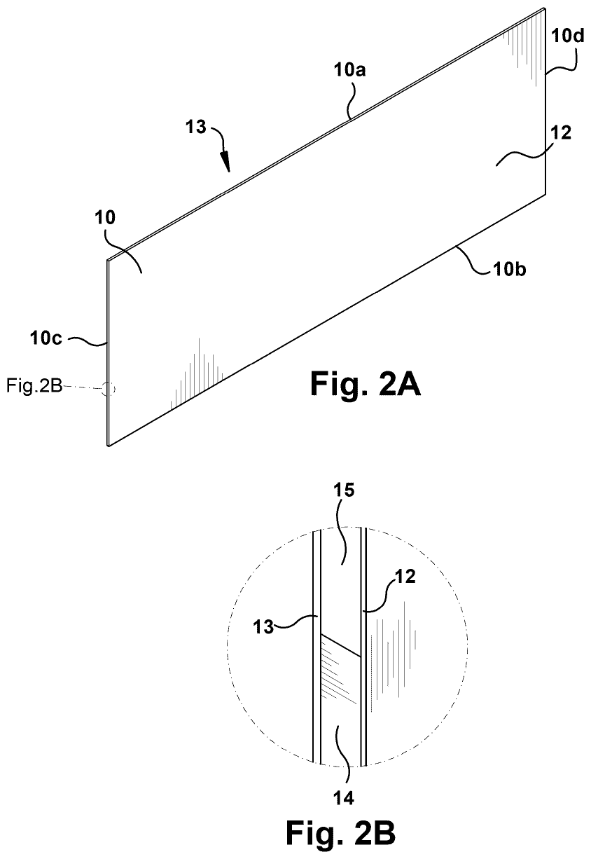

FIG. 2a shows an illustration of a composite wall structure 10, similar to wall 1 of FIG. 1a. Composite wall structure 10 has a top edge surface 10a, a bottom edge surface 10b, a first side surface 10c and a second side surface 10d. Composite wall structure 10 has two exterior faces that include a first wall surface 12 and a second wall surface 13, both respectively formed by an inner polymeric skin and an outer polymeric skin that provide a continuous, smooth surface face to wall 10. The entire bottom edge section of composite wall structure 10 has a thermoplastic laminate reinforcement 14 arranged between inner polymeric skin 12 and outer polymeric skin 13. Thermoplastic laminate reinforcement 14 forms a continuous portion of bottom edge surface 10b along its entire length as it occupies the area between inner polymeric skin 12 and outer polymeric skin 13 at the bottom section of wall 10. Thermoplastic laminate reinforcement 14 also forms a portion of first side surface 10c and second side surface 10d as it occupies the area between inner polymeric skin 12 and outer polymeric skin 13 at the bottom side areas of wall 10.

As shown in FIG. 2b, thermoplastic laminate reinforcement 14 directly contacts core material 15 arranged above. Core material 15 is positioned between inner polymeric skin 12 and outer polymeric skin 13 and occupies the remaining area between skins 12, 13 that is not filled with thermoplastic laminate reinforcement 14. Core material 15 also forms a portion of top edge surface 10a along its entire length as it occupies the area between inner polymeric skin 12 and outer polymeric skin 13 at the top section of wall 10. Portions of first side surface 10c and second side surface 10d are also formed by core material 15 as it occupies the area between inner polymeric skin 12 and outer polymeric skin 13 above the entire top side areas of wall 10.

Although not shown, walls 1, 10 may have an additional thermoplastic laminate reinforcement 4, 14 positioned at the opposite edge such that both the top section and bottom section of the walls include a first and second thermoplastic laminate reinforcement. The first and second thermoplastic laminate reinforcement may be composed of the same materials. The remaining area between the inner polymeric skin 2, 12 and outer polymeric skin 3, 13 is filled with core material 5, 15 positioned between the first and second thermoplastic laminate reinforcement at the top and bottom ends of the wall.

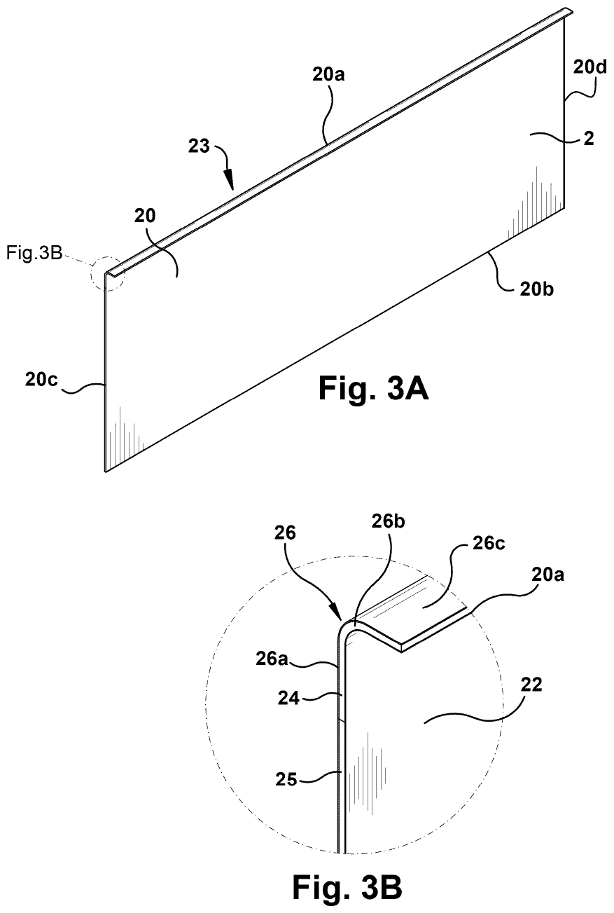

As shown in FIG. 3a, composite wall structure 20 has a top edge surface 20a, a bottom edge surface 20b, a first side surface 20c and a second side surface 20d. A first wall surface 22 and a second wall surface 23, facing opposite one another, are formed by an inner polymeric skin and an outer polymeric skin that provide a continuous, smooth surface face to wall 20. The entire top edge section of composite wall structure 20 has a thermoplastic laminate reinforcement 24 arranged between polymeric skins 22, 23. Below thermoplastic laminate reinforcement 24, is core material 25 that fills the remaining area between polymeric skins 22, 23 below the reinforcement 24 that runs the entire length of the top section of wall 20.

An integrated attachment surface 26 extends along the entire length of the top edge section of composite wall structure 20. Integrated attachment surface 26 has a first section 26a, a second section 26b and a third section 26c. First section 26a extends from top section of the main portion of wall 20 and is continuous and in plane with the remaining portion of wall 20, whereas second section 26b forms a radius, about 90 degrees, such that third section 26c extends from the end of the radius to form a lip that includes a planar section that is substantially perpendicular to the main portion of wall 20. The lip of third section 26c forms the top edge surface 20a.

FIG. 3b illustrates thermoplastic laminate reinforcement 24 occupying the entire area between skins 22, 23 through the sections of integrated attachment surface 26, while also forming a portion of the top edge surface 20a along its length and select portions of first side surface 20c and second side surface 20d near the top corner sections of wall 20. As shown along the bottom edge of thermoplastic laminate reinforcement 24, core material 25 is in continual direct contact with the reinforcement to provide a continuous core in wall 20 between skins 22, 23.

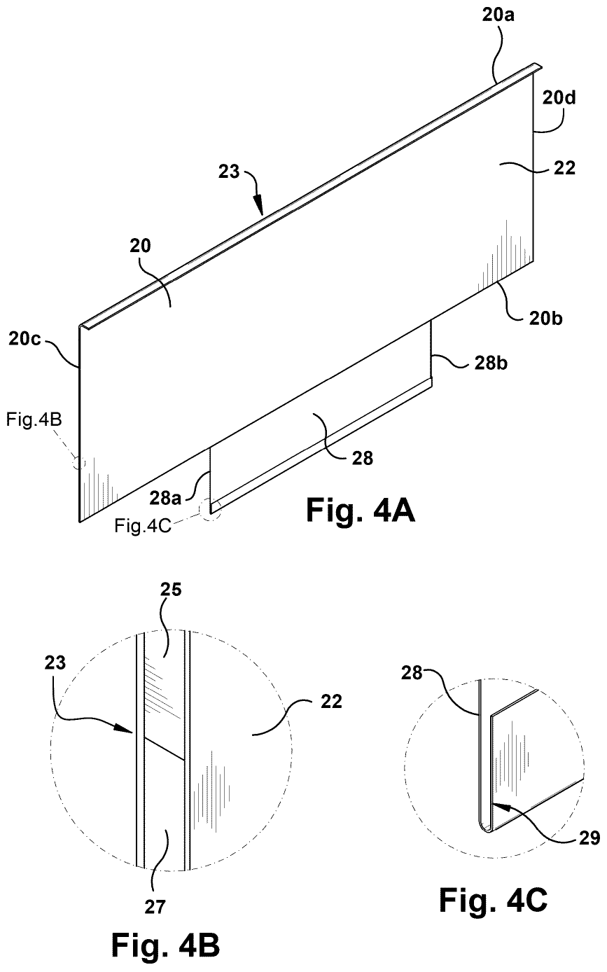

FIG. 4a shows the composite wall structure of FIG. 3a that further includes an aerodynamic extension 28. Aerodynamic extension 28 is made of a portion of outer polymeric skin 23 extending downward and away from bottom edge surface 20b of composite wall structure 20. Along the length of the bottom edge surface 20b of composite wall structure 20, aerodynamic extension 28 is arranged in a center portion with two side ends 28a, 28b that terminate prior to the first side surface 20c and second side surface 20d of wall 20.

FIG. 4b shows that a thermoplastic laminate reinforcement 27 can be positioned along the bottom section of composite wall structure 20 and form a portion of bottom edge surface 20b that is the base from which aerodynamic extension 28 begins to extend downward from wall 20. Thermoplastic laminate reinforcement 27 may also, as shown, abut and contact core material 25 along its entire top edge. By arranging thermoplastic laminate reinforcement 27 along the perimeter edge section and surface from which an aerodynamic extension extends, additional strength and rigidity can be accommodated as the joining base of the aerodynamic extension and wall structure. This will resist damaging movement and flexing that can damage the aerodynamic extension during operation.

FIG. 4c illustrates an example feature of aerodynamic extension 28. An edge surface of aerodynamic extension 28, bottom edge surface shown, may have a lip 29 to provide increased strength to provide resistance to damage during operation. Lip 29 contains a portion of the outer polymeric skin forming aerodynamic extension 28 folded onto itself to create a section of double thickness.

Other alterations or changes to the designs of the embodiment of FIGS. 1 through 4 can also be made. While the invention has been described in connection with various detailed embodiments and figures, the description is not intended to limit the scope of the invention to the particular forms set forth herein, but on the contrary, it is intended to cover such alternatives, modifications, and equivalents as may be included within the spirit and scope of the invention as defined by the appended claims.

1. A composite wall structure for a transportation container, the composite wall structure comprising:
a. a top edge surface, a bottom edge surface, a first side surface and a second side surface;
b. an inner polymeric skin forming a first wall surface;
c. an outer polymeric skin forming a second wall surface;
d. a core material positioned between the inner polymeric skin and the outer polymeric skin;
e. a thermoplastic laminate reinforcement positioned between the inner polymeric skin and the outer polymeric skin, the thermoplastic laminate reinforcement is located at or near the top edge surface or the bottom edge surface of the composite wall structure, and the thermoplastic laminate reinforcement being a different material than the core material,
wherein the core material and the thermoplastic laminate reinforcement are thermally fused to the inner polymeric skin and the outer polymeric skin.

2. The composite wall structure of claim 1, wherein the thermoplastic laminate reinforcement extends along the entire top edge surface or the bottom edge surface.

3. The composite wall structure of claim 1, further comprising a second thermoplastic laminate reinforcement, wherein the thermoplastic laminate reinforcement extends along the entire top edge surface, the second thermoplastic laminate reinforcement extends along the entire bottom edge surface, and the core material is positioned between the thermoplastic laminate reinforcement and the second thermoplastic laminate reinforcement.

4. The composite wall structure of claim 1, wherein the thermoplastic laminate reinforcement abuts and is in direct contact with the core material.

5. The composite wall structure of claim 1, wherein the inner polymeric skin and the outer polymeric skin are continuous and form the respective entire height and width of the first wall surface and the second wall surface.

6. The composite wall structure of claim 1, wherein the top edge surface is thermoformed to form an integrated attachment surface, the integrated attachment surface being non-parallel with the first wall surface and the second wall surface.

7. The composite wall structure of claim 1, wherein the integrated attachment surface is formed as a 90-degree bend at the top edge portion of the wall structure.

8. The composite wall structure of claim 1, wherein the thermoplastic laminate reinforcement is located at the bottom edge surface, and the outer polymeric skin at the bottom edge surface extends downward below the adjacent bottom end of the inner polymeric skin and the thermoplastic laminate reinforcement to form an aerodynamic extension.

9. The composite wall structure of claim 1, wherein the second wall surface and the aerodynamic extension are a continuous surface formed by the outer polymeric skin.

10. The composite wall structure of claim 1, wherein the core materials is a foam material and the thermoplastic laminate reinforcement comprises fiber-reinforced polymeric material, the polymeric material of the thermoplastic laminate reinforcement being the same polymeric material of the inner polymeric skin or the outer polymeric skin.

11. The composite wall structure of claim 1, wherein the core material and the thermoplastic laminate reinforcement are in direct contact with the inner polymeric skin and the outer polymeric skin.

12. The composite wall structure of claim 1, wherein the thermoplastic laminate reinforcement surrounds the entire core material positioned between the inner polymeric skin and the outer polymeric skin.

13. The composite wall structure of claim 1, wherein at least one of the inner polymeric skin and the outer polymeric skin extend past both the core material and the thermoplastic laminate reinforcement.

14. The composite wall structure of claim 1, wherein the entire first wall surface is formed by the inner polymeric skin or the entire second wall surface is formed by the outer polymeric skin.

15. The composite wall structure of claim 1, wherein the top edge surface or the bottom edge surface comprises a portion of the thermoplastic laminate reinforcement extending beyond an edge of the inner polymeric skin or outer polymeric skin.

16. A transportation trailer comprising a front wall, a first sidewall and a second sidewall, the composite wall structure of claim 1 being at least one of the front wall, the first sidewall and the second sidewall of the transportation trailer.

17. A composite wall structure for a transportation container, the composite wall structure comprising:
a. a top edge surface, a bottom edge surface, a first side surface and a second side surface;
b. an inner polymeric skin forming the first side surface;
c. an outer polymeric skin forming the second side surface;
d. a foam core material positioned between the inner polymeric skin and the outer polymeric skin;
e. a first thermoplastic laminate reinforcement positioned between the inner polymeric skin and the outer polymeric skin, the first thermoplastic laminate reinforcement extends along the entire top edge surface;
f. a second thermoplastic laminate reinforcement positioned between the inner polymeric skin and the outer polymeric skin, the second thermoplastic laminate reinforcement extends along the entire bottom edge surface,
wherein the foam core material, the first thermoplastic laminate reinforcement, and the second thermoplastic laminate reinforcement are thermally fused to the inner polymeric skin and the outer polymeric skin, and
wherein the inner polymeric skin and the outer polymeric skin are continuous and form the respective entire height and width of the first side surface and the second side surface.

18. The composite wall structure of claim 17, wherein the wherein the top edge surface is thermoformed to form an integrated attachment surface, the integrated attachment surface being non-parallel with the first side surface and the second side surface.

19. The composite wall structure of claim 17, wherein the outer polymeric skin at the bottom edge surface extends downward below the adjacent bottom end of the inner polymeric skin and the second thermoplastic laminate reinforcement to form an aerodynamic extension.

20. A composite wall structure for a transportation container, the composite wall structure comprising:
a. a composite wall portion that forms a sidewall of the transportation container, the composite wall portion comprising:
i. a top edge surface, a bottom edge surface, a first side surface and a second side surface;
ii. an inner polymeric skin forming the first side surface;
iii. an outer polymeric skin forming the second side surface;
iv. a core material positioned between the inner polymeric skin and the outer polymeric skin; and
b. an aerodynamic extension formed by a portion of the outer polymeric skin extending downward from the composite wall portion and below the inner polymeric skin and a bottom side of the transportation container.
